(19) United States
(12) Patent Application Publication
(10) Pub. No.: US 2006/0090924 A1
(43) Pub. Date: May 4, 2006

(54) FLEXIBLE RIBBON OR FLAT CABLE

(75) Inventors: Denis Reibel, Herrlisheim (FR); Horst Kober, Weinheim (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg K G, Weinheim (DE)

(21) Appl. No.: 10/515,086

(22) PCT Filed: Feb. 15, 2003
(86) PCT No.: PCT/EP03/01536

§ 371 Date: Sep. 13, 2005

(30) Foreign Application Priority Data
May 21, 2002 (DE) 102 22 832.9

(51) Int. Cl. H01B 7/08

(52) U.S. Cl. 174/117 F

(57) ABSTRACT

A flexible ribbon or flat cable which is made of at least one electric current conductor provided with an insulating layer and embedded between at least two non-woven fabric layers. The non-woven fabric layers are made purely of polyester, polyamide, polyolefin, syndiotactic polystyrene, polysulphone and/or glass fibers and are joined together by means of a binding agent.

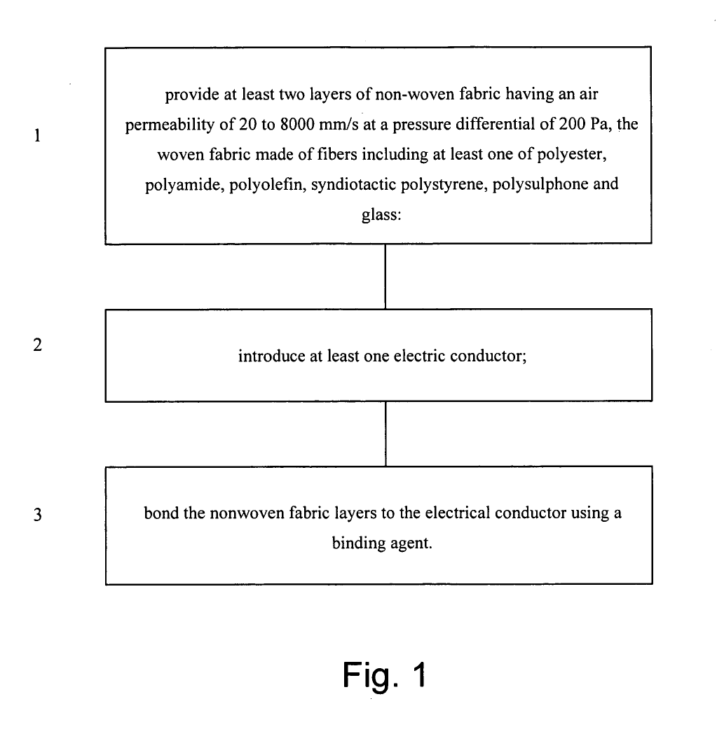

The present invention is directed to a flexible ribbon or flat cable composed of at least one signal lead that is embedded between at least two layers of nonwoven fabric.

From U.S. Pat. No. 5,049,435, flexible printed circuit boards are known, which are reinforced with nonwoven fabrics composed of polyaromatic amides, and which can be used as flat cables. To that end, the nonwoven fabrics composed of polyaromatic amides are impregnated with a heat- and/or light-curable resin.

In addition, U.S. Pat. No. 5,744,756 describes a cable which is insulated by meltblown microfibers.

The object of the present invention is to provide a flexible ribbon or flat cable which is easy and inexpensive to manufacture.

This objective is achieved in accordance with the present invention by a flexible ribbon or flat cable which is composed of at least one electric conductor that is embedded between at least two layers of nonwoven fabric and is provided with an insulation layer, the layers of nonwoven fabric being composed merely of fibers of polyester, polyamide, polyolefin, syndiotactic polystyrene, polysulphone and/or of glass and being bonded together by a binding agent. Surprisingly, the ribbon or flat cables according to the present invention exhibit a dielectric strength and a dimensional stability that meet industry requirements even without the use of polyaromatic amides.

Electric conductors having different cross sections are preferably present in the ribbon or flat cables. The electric conductors advantageously have a thickness of 5 to 200 μm, and they are spaced apart by a distance that is greater than or equal to their thickness. The pitch of the signal leads is advantageously 1.25, 1.27, 2.5 or 2.54 mm.

To improve the flame resistance, the ribbon or flat cable according to the present invention preferably contains flame retardants, which are introduced either together with the binding agent or when laying the nonwoven fabric.

As flame retardants, leather fibers are especially preferred, in particular, leather fiber residues from the production of chrome leather.

The present invention is also directed to a method for manufacturing a ribbon or flat cable, nonwoven fabrics having an air permeability of 20 to 8000 mm/s at a pressure differential of 200 Pa being used, between which at least one signal lead is introduced and bonded using a binding agent.

The binding agent is advantageously applied to the nonwoven fabric layers in liquid, powdery or fibrous form or as a film before the nonwoven fabric layers are bonded to the signal lead.

In accordance with the present invention, as binding agents, thermoplastic polymers, such as polyolefins, polyesters, polyimides, polyamides, polyurethanes, polyacrylates, or nitrile butyl rubber, or cross-linkable systems, such as polyurethanes, epoxy resin systems, or UV cross-linkable products are used.

Especially preferred is a method which provides for the nonwoven fabric layers to be laminated together with the signal lead to form a composite.

The ribbon or flat cables according to the present invention are used for wiring systems in vehicles or in electrical household appliances.

The present invention is elucidated in the following on the basis of examples.

### EXAMPLE 1

A flexible flat cable composed of two spunbonded polyethylene terephthalate fabrics is manufactured by laminating the electrical signal leads having a thickness of 35 μm in between the spunbonded fabrics at a mutual distance of 2.5 mm at 120° C. using an adhesively bonded fabric of copolyamide.

### EXAMPLE 2

A flexible flat cable composed of two spunbonded polyethylene terephthalate fabrics is manufactured by powdering the spunbonded fabrics with a mixture of a copolyamide and an epoxy resin, by laying a plurality of electrical signal leads having a thickness of 35 μm at a mutual distance of 2.54 mm, and laminating the same at 160° C.

### EXAMPLE 3

A flexible flat cable composed of two spunbonded polyethylene terephthalate fabrics is manufactured by powdering the spunbonded fabrics with a polyurethane hot-melt adhesive, by laying electrical signal leads having a thickness of 35 μm at a mutual distance of 2.5 mm, and laminating the same at 165° C.

### EXAMPLE 4

A flexible flat cable composed of two spunbonded polyethylene terephthalate fabrics is manufactured by powdering the spunbonded nonwoven fabrics with a mixture of a copolyester and an epoxy resin, by laying a plurality of electrical signal leads having a thickness of 30 μm at a mutual distance of 2.54 mm, and laminating the same at 175° C.

The dimensional stability attained following a thermal treatment at 140° C. for 30 minutes and 24 hours was assessed by comparing it to that of a standard flat cable of film. The results are summarized in the following table:

| | Shrinkage in % | |
|---|---|---|
| Material designation | 30 minutes at 140° C. | 24 hours at 140° C. |
| Standard cable | −0.03 | −0.30 |
| Example 1 | 0.03 | 0.05 |
| Example 2 | −0.04 | −0.02 |
| Example 3 | 0.04 | 0.05 |
| Example 4 | 0.01 | −0.03 |

1-13. (canceled)

14. A flexible ribbon or flat cable comprising:
at least two layers of nonwoven fabric, the nonwoven fabric made of fibers including at least one of polyester, polyamide, polyolefin, syndiotactic polystyrene, polysulphone and glass bonded together using a bonding agent; and
at least one electric conductor having an insulation layer and embedded between the at least two layers of nonwoven fabric.

15. The ribbon or flat cable as recited in claim 14, wherein the at least one electric conductor includes at least two electric conductors having different cross sections.

16. The ribbon or flat cable as recited in claim 14, wherein the at least one electrical conductor includes at least two electric conductors having a thickness of 5 μm to 200 μm, the at least two electrical conductors being spaced apart by a distance that is greater than or equal to their thickness.

17. The ribbon or flat cable as recited in claim 14, wherein the at least one electrical conductor includes at least two electric conductors configured at a pitch of 1.25, 1.27, 2.5 or 2.54 mm.

18. The ribbon or flat cable as recited in claim 14, further comprising at least one flame retardant.

19. The ribbon or flat cable as recited in claim 18, wherein the flame retardant includes leather fibers.

20. The ribbon or flat cable as recited in claim 18, wherein the flame retardant includes leather fiber residues from the production of chrome leather.

21. The ribbon or flat cable as recited in claim 14, wherein the ribbon or flat cable is part of a wiring system in one of a vehicle and a household appliance.

22. A method for manufacturing a flexible ribbon or flat cable, the method comprising:
providing at least two layers of non-woven fabric having an air permeability of 20 to 8000 mm/s at a pressure differential of 200 Pa, the woven fabric made of fibers including at least one of polyester, polyamide, polyolefin, syndiotactic polystyrene, polysulphone and glass,
introducing at least one electric conductor;
bonding the nonwoven fabric layers to the electrical conductor using a binding agent.

23. The method as recited in claim 22, further comprising applying the binding agent to the nonwoven fabric layers in the form of at least one of a liquid form, a powdery form, a fibrous form, and a film before the bonding.

24. The method as recited in claim 22, wherein the binding agent includes at least one of thermoplastic polyolefins, polyesters, polyimides, polyamides, polyacrylates, polyurethanes, and nitrile butyl rubber.

25. The method as recited in claim 22, the binding agent includes polymers having reactive chemical functions and being mutually cross-linkable in the presence of a supply of energy in the form of at least one of heat, UV radiation, and electron bombardment, wherein the presence of the supply of energy helps to initiate, sustain or promote the cross-linking.
